(19) United States
(12) Patent Application Publication
(10) Pub. No.: US 2014/0052591 A1
(43) Pub. Date: Feb. 20, 2014

(54) Joining Of Logistical And Financial Data Related to Procurement Spending

(71) Applicants: Arnulf Schüler, Heidelberg (DE); Rolf Schumann, Bad Schoenborn (DE); Sven-Eric Eigemann, Sandhausen (DE); Marcel Kieser, Wiesloch (DE); Dagmar Opitz, Sandhausen (DE); Thomas Maag, Reilingen (DE); Huaiyang Mao, Walldorf (DE); Shabana Ansari, Wiesloch (DE); Sonja Zscherpel, Forst (DE); Lan Zhang, Wiesloch (DE)

(72) Inventors: Arnulf Schüler, Heidelberg (DE); Rolf Schumann, Bad Schoenborn (DE); Sven-Eric Eigemann, Sandhausen (DE); Marcel Kieser, Wiesloch (DE); Dagmar Opitz, Sandhausen (DE); Thomas Maag, Reilingen (DE); Huaiyang Mao, Walldorf (DE); Shabana Ansari, Wiesloch (DE); Sonja Zscherpel, Forst (DE); Lan Zhang, Wiesloch (DE)

(73) Assignee: SAP AG, Walldorf (DE)

(21) Appl. No.: 13/589,941

(22) Filed: Aug. 20, 2012

(51) Int. Cl. G06Q 40/00

(52) U.S. Cl. 705/30

(57) ABSTRACT

A system, method, and computer program product for joining logistical and financial data related to procurement spending in a database. Financial data can be replicated from a first source to an analytics database. Procurement data from a second source can be replicated to the analytics database. The financial data can be filtered for procurement-related items to obtain procurement-related financial data. The obtained procurement financial data can be joined with the procurement data in the analytics database based on related information between the financial data and the procurement data. One or more reports based on the joined financial and procurement data can be generated in the analytics database. Related apparatus, systems, techniques and articles are also described.

### TECHNICAL FIELD

This disclosure relates generally to data processing and in particular, to joining logistical and financial data related to procurement spending in a database.

### BACKGROUND

While expenditures are generally recorded as financial data (Financials) in many database systems, some essential information for analysis is missing for procurement purposes. On the other hand, spending information, which is typically recorded as logistics data in many database systems, may contain some of the necessary information for meaningful analysis for procurement purposes (e.g., material groups, plants, etc.). Looking only at the overall picture from logistics perspectives alone can lead to missing out on expenditures incurred outside of procurement processes because those expenditures would only turn up in the Financials (and not procurement). Additionally, important information such as subsequent postings in the Financials may not be transparent to supply managers (e.g. credit memos to accounts for price reduction due to quality issues, subsequent postings to accounts for quantity discounts at yearend, etc.). However, financial data and logistics data typically have different document structures, and are not readily combinable.

### SUMMARY

In some implementations, the current subject matter relates to methods, systems, and articles for replicating financial data from a first source to an analytics database, replicating procurement data from a second source to the analytics database, filtering the financial data for procurement-related items to obtain procurement-related financial data, joining the obtained procurement financial data with the procurement data in the analytics database based on related information between the financial data and the procurement data, and generating one or more reports based on the joined financial and procurement data in the analytics database. At least one of the above can be performed on at least one processor.

In some implementations, the current subject matter can include one or more of the following optional features. The procurement data being joined with the procurement-related financial data can include material information. The procurement data being joined with the procurement-related financial data can include contract information. In some implementations, the method can further include filtering the financial data for nonprocurement-related data, and generating one or more additional reports based on non-procurement-related data.

In some implementations, the analytics database utilizes in-memory technology. In some implementations, the in-memory database system can be a high performance analytic appliance system.

In some implementations, the joining includes creating a new table based on a first table containing the obtained procurement-related financial data and a second table containing the procurement data.

Non-transitory computer program products are also described that store instructions, which when executed by one or more data processors, causes at least one data processor to perform operations herein. Similarly, computer systems are also described that may include a processor and a memory coupled to the processor. The memory may temporarily or permanently store one or more programs that cause the processor to perform one or more of the operations described herein. In addition, operations specified by methods can be implemented by one or more data processors either within a single computing system or distributed among two or more computing systems.

The subject matter described herein provides many advantages. For example, by joining logistics data with financial data, a more complete control of procurement spending can be achieved. By combining the data and making the activities more transparent, the subject matter described herein enables more well-founded decision making, for example, as to whether to include those activities in controlled procurement processes (e.g. to gain additional savings) or to purposely exclude them (e.g. when specific low cost items do not warrant the administrative overhead).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a system including a data storage application;

FIG. 2 is a diagram illustrating details of the system of FIG. 1;

FIG. 3 is a process flow diagram illustrating an exemplary process according to implementations of the current subject matter;

FIG. 4 shows an exemplary database in which various financial data and procurement data are combined;

FIG. 5 is an illustration of an exemplary database containing logistical and financial data; and

FIGS. 6-13 illustrate an exemplary user interface including spending analysis dashboard for logistics and financials in accordance with some implementations of the present subject matter.

### DETAILED DESCRIPTION

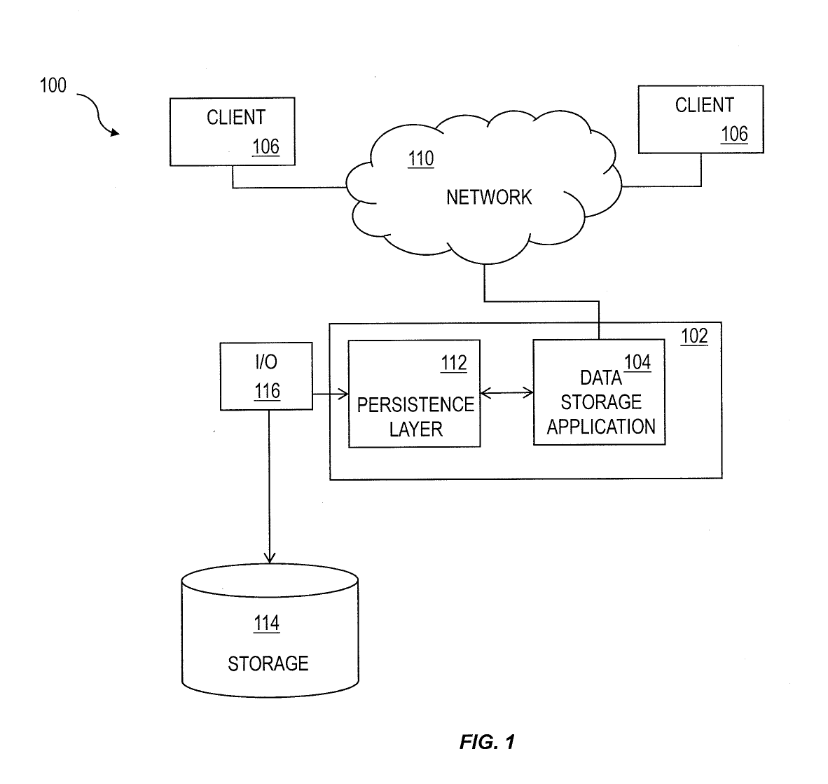

FIG. 1 shows an example of a system 100 in which a computing system 102, which can include one or more programmable processors that can be collocated, linked over one or more networks, etc., executes one or more modules, software components, or the like of a data storage application 104. The data storage application 104 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 102 as well as to remote users accessing the computing system 102 from one or more client machines 106 over a network connection 110. One or more user interface screens produced by the one or more first modules can be displayed to a user, either via a local display or via a display associated with one of the client machines 106. Data units of the data storage application 104 can be transiently stored in a persistence layer 112 (e.g. a page buffer or other type of temporary persistency layer), which can write the data, in the form of storage pages, to one or more storages 114, for example via an input/output component 116. The one or more storages 114 can include one or more physical storage media or devices (e.g. hard disk drives, persistent flash memory, random access memory, optical media, magnetic media, and the like) configured for writing data for longer term storage. It should be noted that the storage 114 and the input/output component 116 can be included in the computing system 102 despite their being shown as external to the computing system 102 in FIG. 1.

Data retained at the longer term storage 114 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

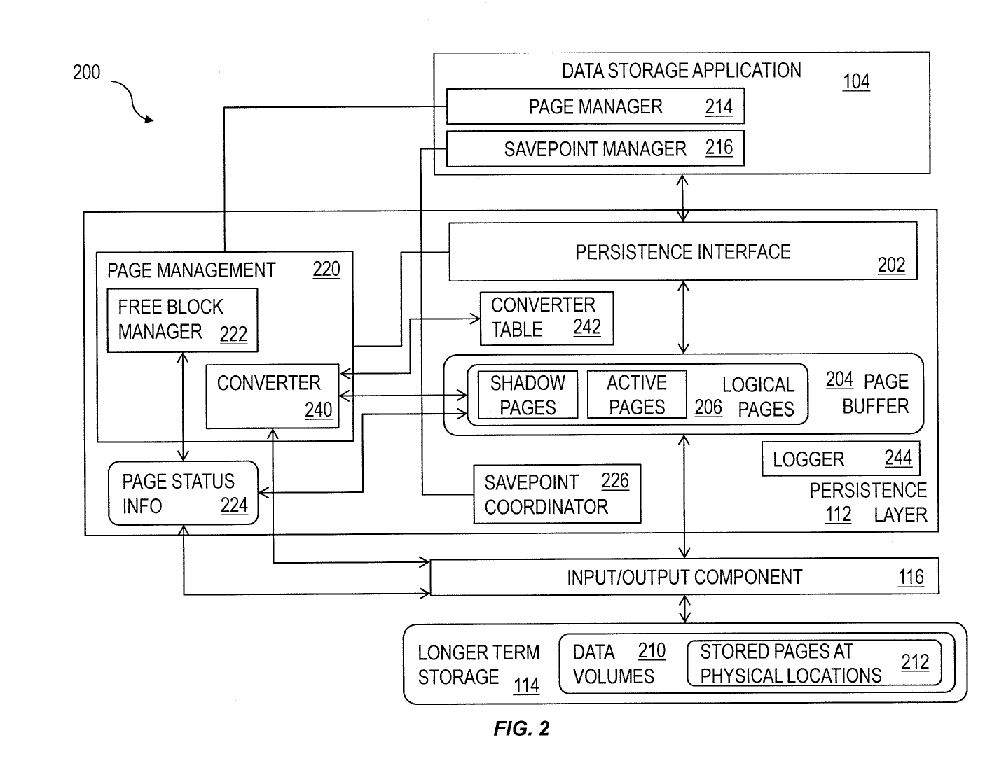

FIG. 2 shows a software architecture 200 consistent with one or more features of the current subject matter. A data storage application 104, which can be implemented in one or more of hardware and software, can include one or more of a database application, a network-attached storage system, or the like. According to at least some implementations of the current subject matter, such a data storage application 104 can include or otherwise interface with a persistence layer 112 or other type of memory buffer, for example via a persistence interface 202. A page buffer 204 within the persistence layer 112 can store one or more logical pages 206, and optionally can include shadow pages, active pages, and the like. The logical pages 206 retained in the persistence layer 112 can be written to a storage (e.g. a longer term storage, etc.) 114 via an input/output component 116, which can be a software module, a sub-system implemented in one or more of software and hardware, or the like. The storage 114 can include one or more data volumes 210 where stored pages 212 are allocated at physical memory blocks.

In some implementations, the data storage application 104 can include or be otherwise in communication with a page manager 214 and/or a savepoint manager 216. The page manager 214 can communicate with a page management module 220 at the persistence layer 112 that can include a free block manager 222 that monitors page status information 224, for example the status of physical pages within the storage 114 and logical pages in the persistence layer 112 (and optionally in the page buffer 204). The savepoint manager 216 can communicate with a savepoint coordinator 226 at the persistence layer 112 to handle savepoints, which are used to create a consistent persistent state of the database for restart after a possible crash.

In some implementations of a data storage application 104, the page management module of the persistence layer 112 can implement a shadow paging. The free block manager 222 within the page management module 220 can maintain the status of physical pages. The page buffer 204 can included a fixed page status buffer that operates as discussed herein. A converter component 240, which can be part of or in communication with the page management module 220, can be responsible for mapping between logical and physical pages written to the storage 114. The converter 240 can maintain the current mapping of logical pages to the corresponding physical pages in a converter table 242. The converter 240 can maintain a current mapping of logical pages 206 to the corresponding physical pages in one or more converter tables 242. When a logical page 206 is read from storage 114, the storage page to be loaded can be looked up from the one or more converter tables 242 using the converter 240. When a logical page is written to storage 114 the first time after a savepoint, a new free physical page is assigned to the logical page. The free block manager 222 marks the new physical page as “used” and the new mapping is stored in the one or more converter tables 242.

The persistence layer 112 can ensure that changes made in the data storage application 104 are durable and that the data storage application 104 can be restored to a most recent committed state after a restart. Writing data to the storage 114 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 244 can also be included to store the changes made to the data of the data storage application in a linear log. The logger component 244 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 244 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 112 can use a combination of undo log entries (from one or more logs) and shadow paging.

The persistence interface 202 can handle read and write requests of stores (e.g., in-memory stores, etc.). The persistence interface 202 can also provide write methods for writing data both with logging and without logging. If the logged write operations are used, the persistence interface 202 invokes the logger 244. In addition, the logger 244 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 244. For an entry of type “update”, for example, this would be the identification of the affected record and the after image of the modified data.

When the data application 104 is restarted, the log entries need to be processed. To speed up this process the redo log is not always processed from the beginning Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 244 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 244 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 244 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 104 can use shadow paging so that the savepoint manager 216 can write a transactionally-consistent savepoint. With such an arrangement, a data backup comprises a copy of all data pages contained in a particular savepoint, which was done as the first step of the data backup process. The current subject matter can be also applied to other types of data page storage.

By nature, financial data is more precise than procurement data since each transaction typically involves a payment in the end, which gets recorded in Financials at some point in time. On the other hand, procurement data is more detailed and includes, for example, what was consumed, by whom, where, and when. Even the original requester and the budget owner for the request can be recorded in the procurement data. Hence, there is an added value in combining these two data sources.

In order to provide a holistic view of the spending by a business, the current subject matter combines financial and procurement data. In some embodiments, financial data is reconciled with procurement data at the document item level to enable reporting of financial spending according to dimensions relevant in procurement (e.g. responsibilities in procurement are usually along the lines of material groups, plants, etc.). Thus, financial spending with documents from logistics (e.g. purchase orders, goods/service receipts, logistics invoices, etc.) can be reported based on dimensions relevant to procurement professionals, while financial spending without documents from logistics can indicate that those procurement activities have not yet been controlled by the procurement process. Making those activities transparent enables better decision-making, such as whether to include those activities in controlled procurement processes (e.g. to gain additional savings) or to purposely exclude them (e.g. when specific low cost items do not warrant the administrative overhead). To make it possible to go through the usually massive amounts of data in the relevant financial database tables and enriching the results with indispensable information from equally massive procurement tables to arrive at a meaningful analysis, system 100 described above with reference to FIGS. 1 and 2 is employed in some implementations. In some implementations, analytics database using in-memory technology, such as the HANA DB from SAP AG, Walldorf, Germany, is utilized.

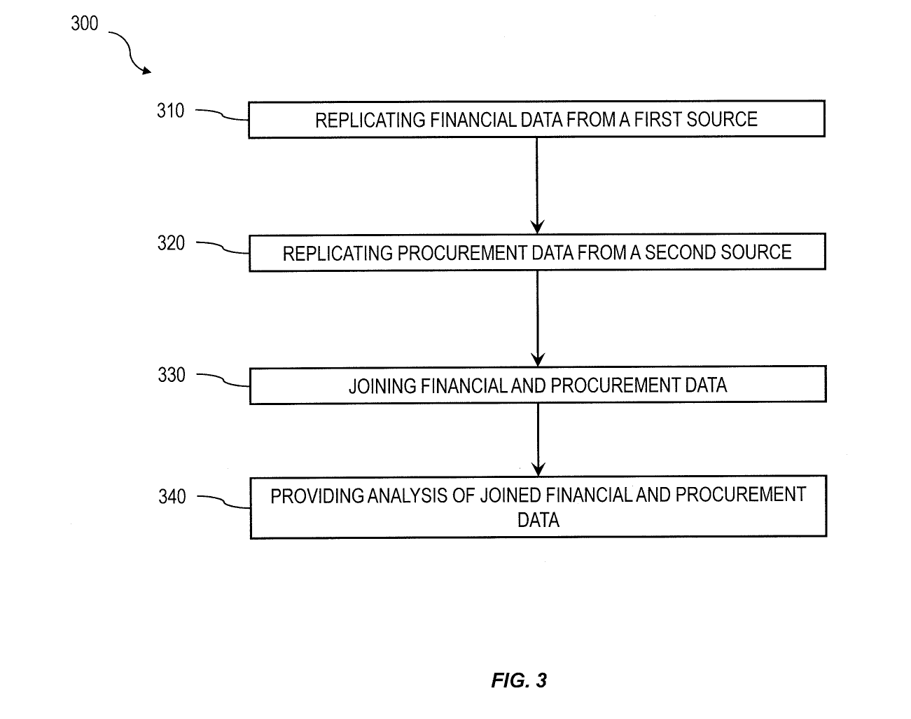

References will now be made to FIG. 3, which illustrates exemplary processes for joining financial data and procurement data, according to some implementations of the current subject matter.

As shown in FIG. 3, financial data and procurement data can be obtained in steps 310 and 320 and replicated from one or more client suite database into an analytics database. It should be noted that the ordering of these steps may be changed. For example, procurement data can be obtained (and/or replicated) before or simultaneously with financial data. At step 330, related financial data and procurement data are joined to provide combined data, including replicated data (e.g. business object data from the financial data and procurement data). In some implementations, this is performed at the document item level. In some implementations, this is performed in real time. At step 340, one or more analyses are provided based on the joined financial and procurement data. These analyses can be stored, for example, as calculation views in the analytics database.

In some implementations, the financial data is filtered down to spending-related items. Those items that contain a reference to procurement documents are enriched (e.g. combined) with additional information not available in Financials, such as material or contract information. Items in Financials that do not result from logistic procurement processes provide a valuable indication about spending which elude management control by the procurement department. Various reports including, for example, reports showing items in Financials that do not result from logistic procurement processes, can be generated for analysis.

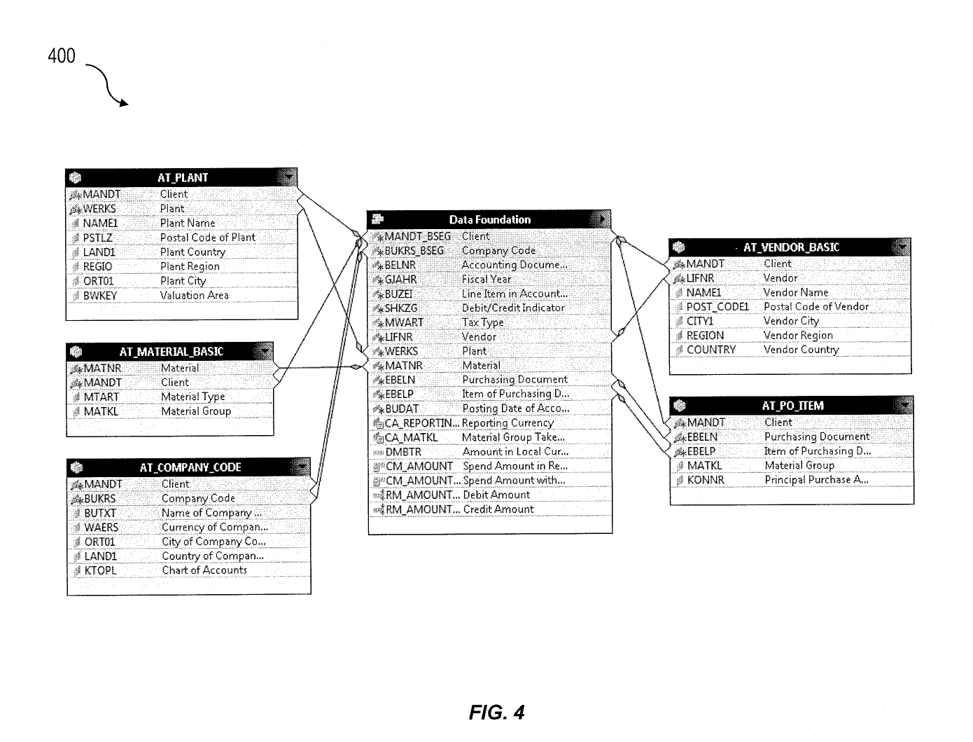

FIG. 4 shows an exemplary database in which various financial data and procurement data are combined. In this example, data such as Plant, Material Basic, Company Code, Vendor Basic, and PO Item are combined to the Data Foundation based on common data such as “Client,” and the related data (for example, Plant, Material, Company Code, Vendor, Purchasing Document, Item of Purchasing, etc.) are joined to the Data Foundation.

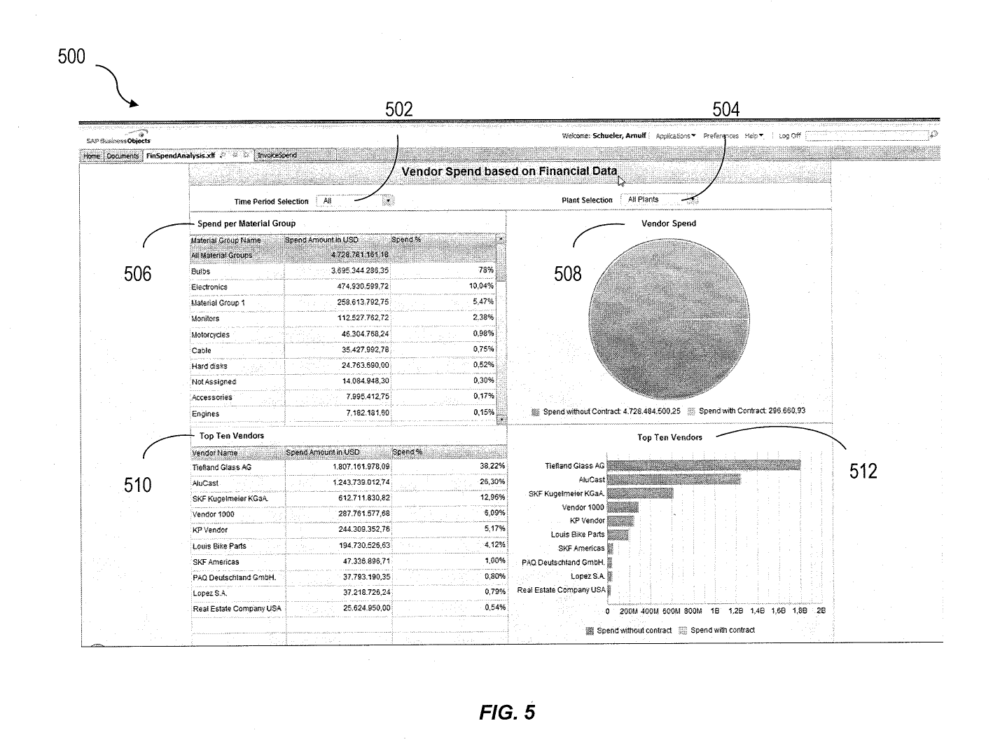

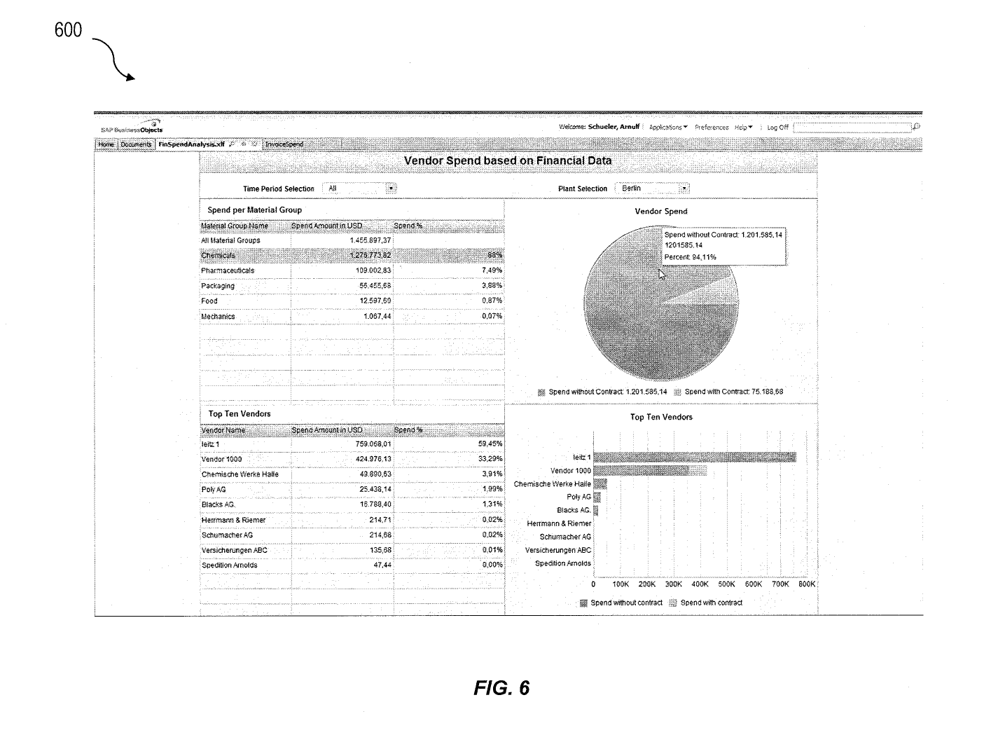

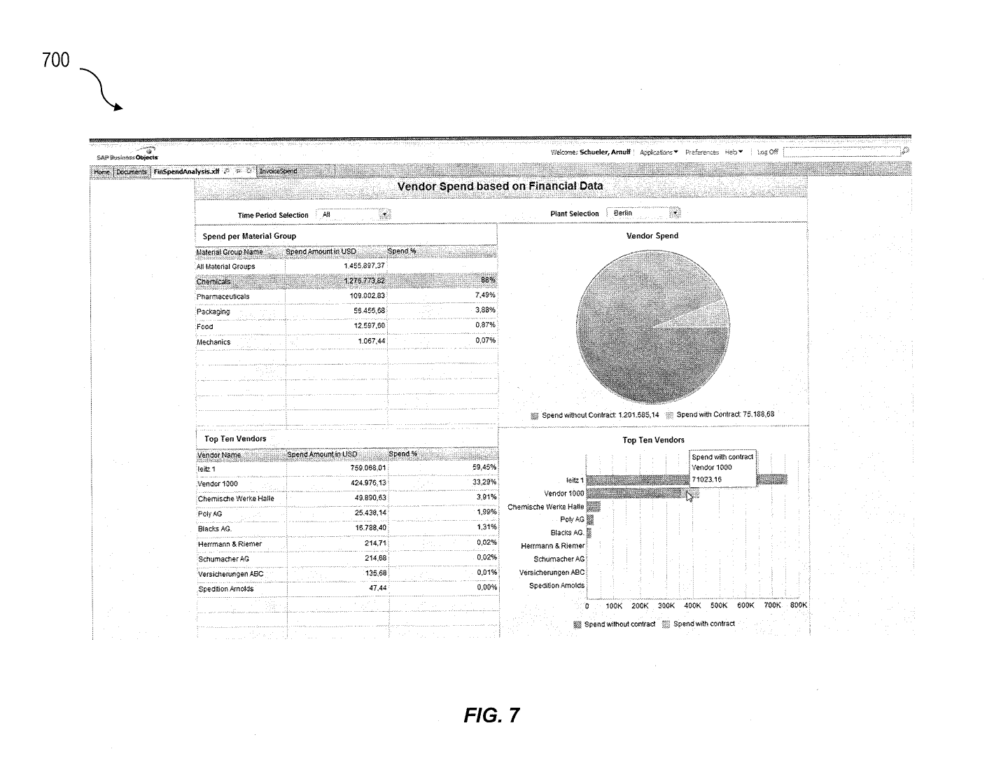

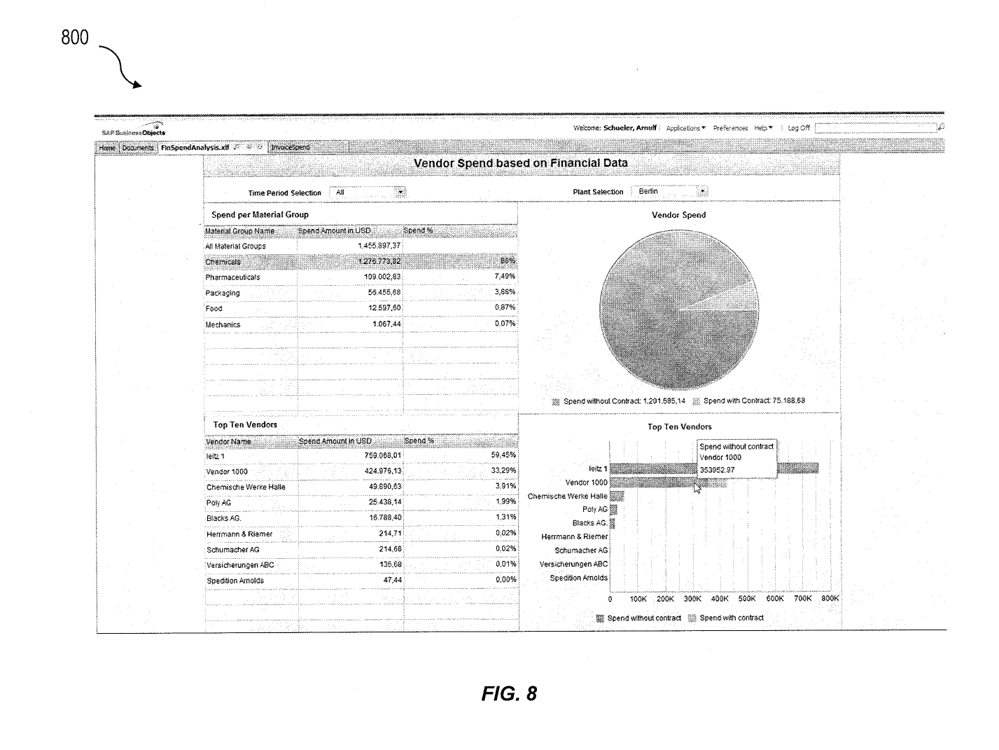

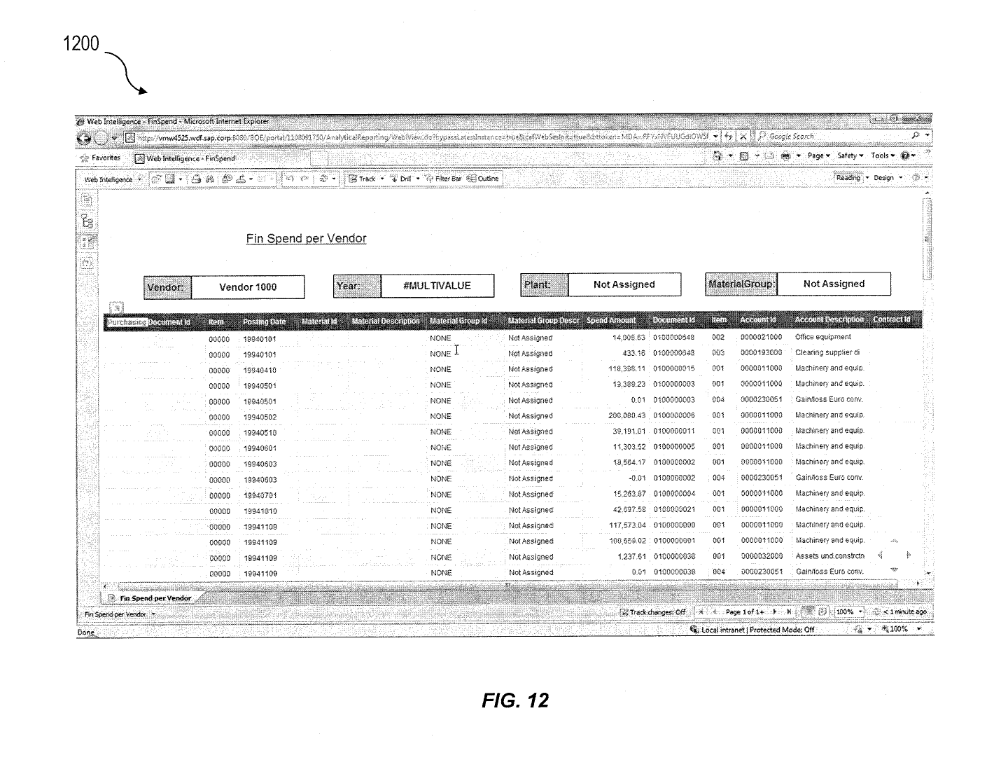

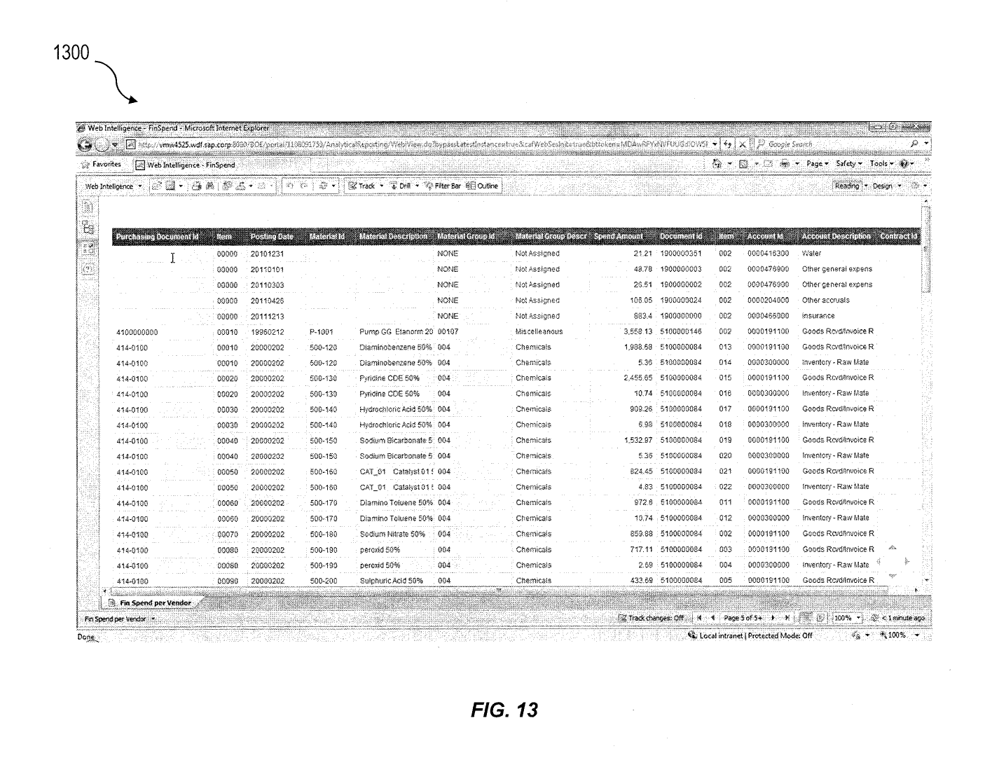

In some implementations, a user interface including a spending analysis dashboard for logistics and financials is provided. Examples of the user interface including the spending analysis dashboard are shown in FIGS. 5-13. As shown in FIG. 5, the dashboard 500 can present an easily navigable spending overview, which includes, for example, per year, plant, material group and vendor. The dashboard can include one or more of the following features: Selection Section (502, 504), which allows a user to filter for the required calendar year and plant. Spending per Material Group (506), which shows the spending amount and percentage per material group for the selected year and plant. Vendor spending (508), which shows the breakdown of spending by contract-based spending (see FIG. 7). and non-contract-based spending (see FIGS. 6 and 8) for the material group selected in the Spending per Material Group view. Top Ten Vendors (510), which shows the top ten vendors regarding the spending amount and percentage for the material group selected in the Spending Material Group view. Top Ten Vendors (512, e.g. broken down by contract/off-contract spending), which shows the top ten vendors regarding the spending amount for the material group selected in the Spending per Material Group view, divided in contract-based spending and non-contract-based spending.

In FIG. 6, the plant “Berlin” is selected (i.e. as a filter) and various related data and reports related thereto are shown in the dashboard 600. A pie chart of the “Vendor Spend” report is provided, showing the Spend without Contract and the Spend with Contract. When the cursor is moved over a part of the pie chart, the corresponding data is provided. Similarly, as shown in FIGS. 7 and 8, when the cursor is moved over a part of the bar chart, corresponding data is provided in the user interface (i.e. the Spend with Contract of Vendor 1000, and the Spend without Contract of Vendor 1000).

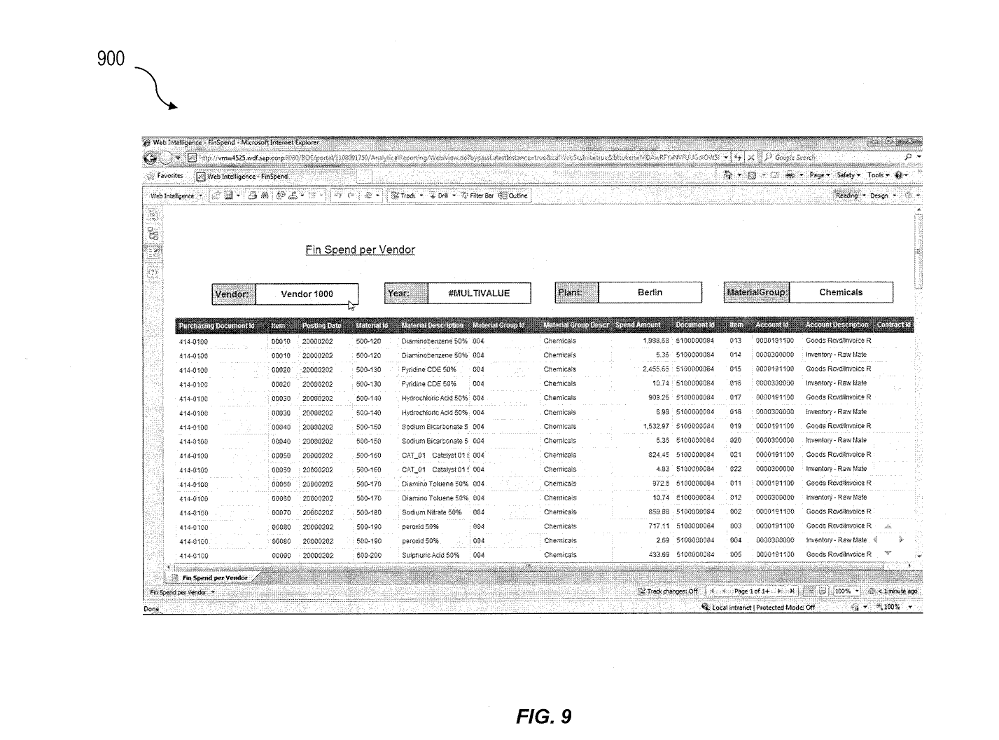

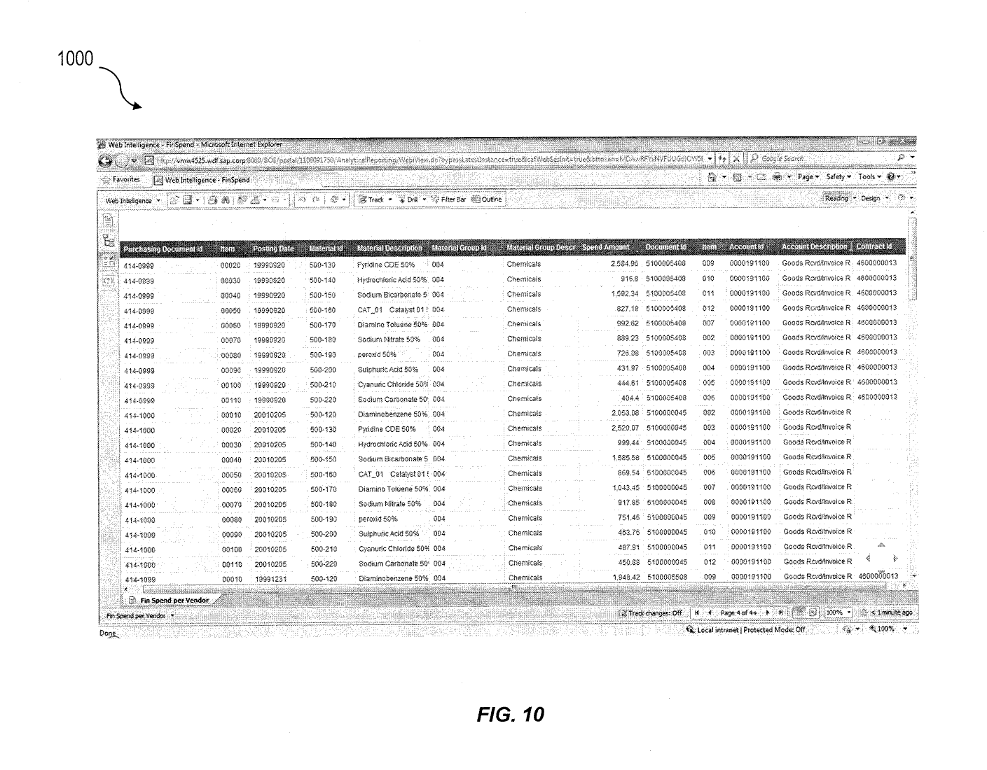

The user interface also provides access to detailed data based on the criteria selected by the user. For example, FIGS. 9 and 10 show various data relating to Vendor 1000, for the Berlin plant, in the Chemicals material group.

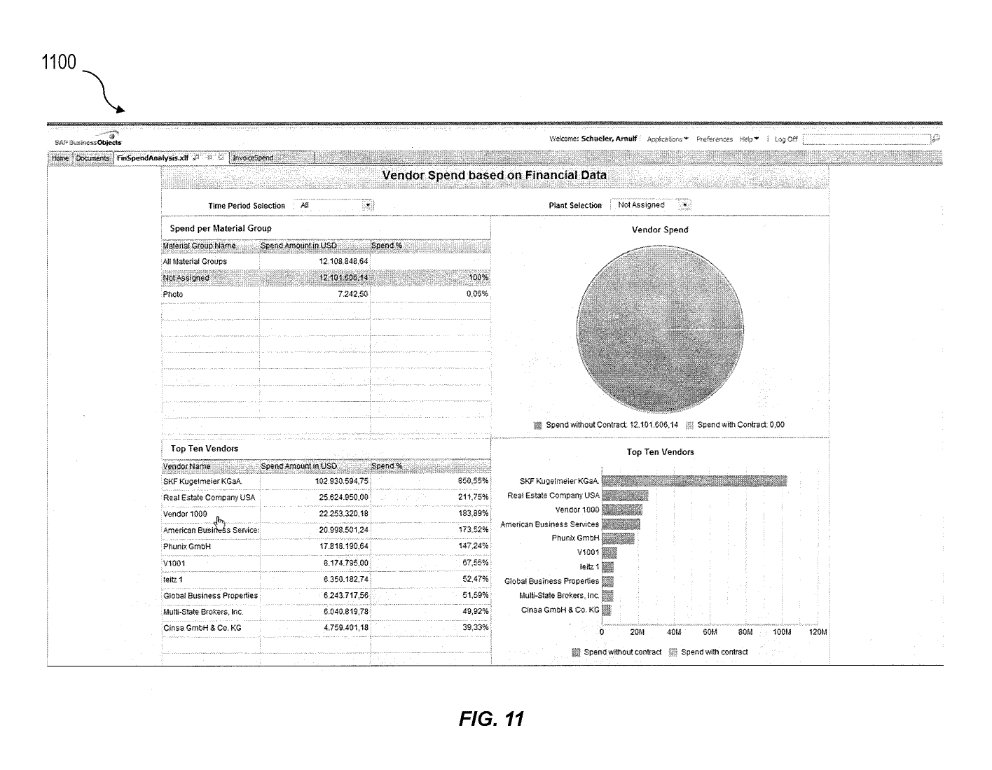

The user may also de-select various filters to generate different reports. For example, FIGS. 11-13 show various related data and reports when the Plant filter has been de-selected, and all material group filter is selected.

References will now be made to FIG. 5, which shows an exemplary database. In this database, there are two main tables BSEG (Accounting Document Segment (means items)) and BKPF (Accounting Document Header), which contain the complete financial data of a company. The financial data can be filtered to obtain procurement-related documents. However, the document structures of the logistics data and the financial data are different and are not readily combinable without additional processing. For example:

Logistics data may include:
Header, which may include, for example, Document Number, Creditor, Gross Amount, and other information.
Items, which may include, for example, Materials, Quantity, Net Price, Net Amount, and other information.

Financial data may include:
Header, which may include, for example, Document Number, Date, and other information.
Items (Logistics header may also be included in items), which may include, for example:
   Debit: Creditor, Gross Amount;
   Credit: Materials, Net Amount;
   Credit: Tax, Tax Amount; or
   Debit: Materials, Net Amount;
   Debit: Tax, Tax Amount;
   Credit: Creditor, Gross Amount.

In order to join the creditor items on BSEG with the items which belong to the credit items, the BSEG is joined with itself based on (mainly) financials document number. Since only the Net Amount of the Materials may be of interest, the Creditor items are not considered and the tax items may be removed view a filter.

An exemplary abstraction of the process in accordance with some implementations is as follows:

Table 1: BSEG (considering Creditors) <----->
Table 2: BSEG (considering materials)

Join: MANDT (Client), BUKRS, (Company Code), BELNR (Accounting
Document Number), GJAHR (Fiscal Year)
Filters:

| | |
|---|---|
| BSCHL(Posting Key) in (21, 22, | MWART (Tax Type) not in |
| 31, 32) | (A, V) |
| KOART (Account Type) = K | KOART (Account Type) not K |

XUMSW (Indicator: Sales-Related Item ?) = X
Legend:
Posting Keys:
21 Credit memo
22 Reverse invoice
31 Invoice
32 Reverse credit memo
Account Type:
K Creditor
Tax types:
A Output tax
V Input tax

Further Joins:

Table 1 BSEG may be joined with Table LFA1 containing the creditors on field LIFNR (Account Number of Vendor or Creditor).

Table 2 BSEG may be joined with Table BKPF (There are some filters in addition for performance reasons only).

Table 2 may be joined with several views (containing tables and table joins). The Join between BSEG and BKPF is called Data Foundation.

In some implementations, these joins are LEFT JOINS (or LEFT OUTER JOINS) in which all data from the data foundation is selected and if data in the other views is associated then this data will be selected as well. Otherwise, a Null-Value is available which can use for further analysis (see below) or for showing nothing (e.g. on a user interface UI).

Calculations:

The SHKZG (Debit/Credit Indicator) may be used to calculate the amount with the correct sign.

The contract number of view at_po_item may be used to calculate the contract related amount: Expression if(isnull(“AT_PO_ITEM_KONNR”) OR “AT_PO_ITEM_KONNR”=“,“CM_AMOUNT”,0).

Sum lines may be created for all dimensions (Year, Plan, Material Group, Vendor) on the fly while delivering data to the user interface (UI dashboard).

If there is no purchasing document, then it can be determined that the spend is not handled in logistics

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

1. A method implemented on a computer comprising one or more data processors and one or more computer-readable media, comprising:
replicating, by one or more data processors, financial data from a first source to an analytics database implemented on one or more computer-readable media;
replicating, by one or more data processors, procurement data from a second source to the analytics database;
filtering, by one or more data processors, the financial data for one or more nonprocurement-related items and procurement-related items to obtained procurement-related financial data;
joining, by one or more data processors, the obtained procurement financial data with the procurement data in the analytics database based on related information between the financial data and the procurement data, the joining comprising creating a new database table based on a first table containing the obtained procurement-related financial data and a second table containing the procurement data; and
generating, by one or more data processors, one or more reports based on the one or more nonprocurement-related items and the joined financial and procurement data in the analytics database.

2. A computer-implemented method according to claim 1, wherein the procurement data being joined with the procurement-related financial data include material information.

3. A computer-implemented method according to claim 1, wherein the procurement data being joined with the procurement-related financial data include contract information.

4. (canceled)

5. A computer-implemented method according to claim 1, wherein the analytics database utilizes in-memory technology.

6. (canceled)

7. A non-transitory machine-readable medium storing instructions that, when executed by at least one programmable processor, cause the at least one programmable processor to perform operations comprising:
replicating financial data from a first source to an analytics database;
replicating procurement data from a second source to the analytics database;
filtering the financial data for one or more nonprocurement-related items and procurement-related items to obtained procurement-related financial data;
joining the obtained procurement financial data with the procurement data in the analytics database based on related information between the financial data and the procurement data; and
generating one or more reports based on the one or more nonprocurement-related items and the joined financial and procurement data in the analytics database.

8. A non-transitory machine-readable medium according to claim 7, wherein the procurement data being joined with the procurement-related financial data include material information.

9. A non-transitory machine-readable medium according to claim 7, wherein the procurement data being joined with the procurement-related financial data include contract information.

10. (canceled)

11. A non-transitory machine-readable medium according to claim 7, wherein the analytics database utilizes in-memory technology.

12. A non-transitory machine-readable medium according to claim 7, wherein the joining includes creating a new table based on a first table containing the obtained procurement-related financial data and a second table containing the procurement data.

13. A system comprising:
at least one programmable processor; and
a machine-readable medium storing instructions that, when executed by the at least one programmable processor, cause the at least one programmable processor to perform operations comprising:
replicating financial data from a first source to an analytics database;
replicating procurement data from a second source to the analytics database;
filtering the financial data for one or more nonprocurement-related items and procurement-related items to obtained procurement-related financial data;
joining the obtained procurement financial data with the procurement data in the analytics database based on related information between the financial data and the procurement data; and
generating one or more reports based on the one or more nonprocurement-related items and the joined financial and procurement data in the analytics database.

14. A system according to claim 13, wherein the procurement data being joined with the procurement-related financial data include material information.

15. A system according to claim 13, wherein the procurement data being joined with the procurement-related financial data include contract information.

16. (canceled)

17. A system according to claim 13, wherein the analytics database utilizes in-memory technology.

18. A system according to claim 17, wherein the analytics database is implemented on a high performance analytic appliance system.

19. A system according to claim 13, wherein the joining includes creating a new table based on a first table containing the obtained procurement-related financial data and a second table containing the procurement data.
